(19) United States
(12) Patent Application Publication
(10) Pub. No.: US 2004/0164173 A1
(43) Pub. Date: Aug. 26, 2004

(54) Nozzle for generating a high-pressure jet

(76) Inventor: Michael Jarchau, Oelde (DE)

Correspondence Address: BARNES & THORNBURG, 750-17TH STREET NW, SUITE 900, WASHINGTON, DC, 20006, US

(21) Appl. No.: 10/683,284

(22) Filed: Oct. 14, 2003

(30) Foreign Application Priority Data
Oct. 17, 2002 (DE) 102 48 3574-51

(51) Int. Cl. B05D 1/00

(52) U.S. Cl. 239/1; 239/589; 239/596; 239/600; 239/591

(57) ABSTRACT

A nozzle for generating a high-pressure jet of a flowable medium, having a nozzle body (1) and a nozzle disk (2) which is embedded therein in a recess (7), consists of a high-strength material, and has an axial, preferably centric nozzle bore (3) which leads into an inlet and/or outlet bore (4, 5), is designed such that the nozzle disk (2) rests under compressive strain on the contact surfaces of the recess (7).

The present invention relates to a nozzle for generating a high-pressure jet according to the preamble of Claim 1.

Such a nozzle is a component of a nozzle head which is used, for example, as a water jet nozzle in the high-pressure water jet technology field. Such a water jet nozzle is used, for example, for the cleaning of surfaces, the removal of coatings, the roughening of surfaces as well as the cutting and separating of materials.

For generating the high-pressure jet, the pressure generated by a pump in a volume flow of the medium is converted by means of a diminishing of the cross-section of the nozzle into a jet, preferably a liquid jet, having a high velocity. Water is normally used as the liquid. The generated pressures can amount to up to 4,000 bar and more, while the velocity is at up to 900 m/s.

Because of the resulting extremely high stressing of the nozzle disk, it is known from German Patent Document DE 94 19 809 U1 to produce this nozzle disk of a sapphire.

However, for obtaining a fairly acceptable service life, it is necessary to machine the nozzle disk as well as the recess, in which it is disposed, within very narrow tolerance limits with respect to the parallelism of the contact surfaces, the concentricity and the angularity as well as the dimensional accuracy. Apart from the fact that this can be done only at considerable manufacturing expenditures, even the low tolerances result in an extremely high stressing of the nozzle disk during the operation, which has a considerable influence on the service life.

Although it is not explicitly mentioned in German Patent Document DE 94 19 809 U1, in practice, the nozzle disk is provided with a sealing ring which is made of a nonferrous heavy metal alloy or of a plastic material and which seals the nozzle disk off with respect to the lateral wall area of the recess of the nozzle body.

However, the sealing ring is not capable of laterally supporting the nozzle disk, as would be required for absorbing tensions acting upon the nozzle disk, which tensions are generated by the high internal pressure in the nozzle bore. This non-existing radial support of the nozzle disk frequently leads to cracks and breaks during the operation, which results in dangerous situations, particularly when such nozzles are used in manually guided tools, such as spray guns or the like. As a result of the abrupt relaxation of the pressure during the breaking of the nozzle disk, the recoil power rises unexpectedly and unacceptably high, which may endanger the user of the spray gun.

In the case of the known nozzle, an axial prestressing force is applied to the nozzle disk as well as the nozzle body by way of a pressure screw. In this case, the force is guided to the nozzle body by way of the nozzle disk and the sealing ring.

However, this requires that corresponding height tolerances of the components are observed at high manufacturing expenditures. Nevertheless, an exceeding of the tightening torque on the pressure screw may result in a breaking of the brittle nozzle disk. This occurs relatively frequently because many nozzles are used and mounted under rough operating conditions, for examples, at construction sites for the renewal of concrete.

The above-mentioning absent radial support of the nozzle disk also leads to high stress caused by dirt particles situated in the jet liquid which, when impacting on the assigned face of the nozzle disk, may also result in cracks with the above-described effects.

It is therefore an object of the present invention to further develop a nozzle of the above-mentioned type such that it can be produced more easily; that its service life is prolonged; and that the operational reliability is improved.

This object is achieved by means of a nozzle which has the characteristics of Claim 1.

A nozzle constructed in this manner has considerable advantages in comparison to the known nozzle.

The first advantage is that the nozzle disk now rests in the recess of the nozzle body in a virtually fixedly clamped-in manner, specifically in all stress situations possible during the operation of the nozzle.

In particular, effective radial forces, which result from the internal operating pressure within the nozzle bore, are directed directly onto the nozzle body. As a result, the nozzle disk becomes extremely resistant, so that a sudden crack formation or breaking is virtually excluded. The sensitivity with respect to dirt particles is also considerably reduced.

According to an advantageous further development of the invention, the nozzle body with the inserted nozzle disk is produced as a constructional unit and can be assembled such that no direct pressure forces act upon the nozzle disk during the assembly, for example, by means of a pressure screw or an inflow body operating in this manner.

In this case, the nozzle disk can be arranged in the interior of the nozzle body.

This means that the nozzle disk is enclosed on all sides by the nozzle body.

Applied tension forces for fixing the nozzle body are thereby guided exclusively into the nozzle body.

This is also the case when the nozzle disk rests in the recess then made on the face-side in the nozzle body, in which case the inflow body, as the pressure piece, braces the nozzle body against a housing bottom, and the tension pressure originating from the inflow body is guided outside the nozzle disk into the nozzle body.

According to an advantageous further development of the invention, it is provided that the nozzle body is produced by sintering or casting, in which case the nozzle disk is inserted beforehand so that it is completely enclosed by the material of the nozzle body after the casting or sintering.

As a result, a special machining precision with respect to the nozzle disk is not necessary which naturally saves expenses.

The nozzle body material, into which the nozzle disk is first embedded without any nozzle bore, is preferably corrosion-resistant and of a high strength.

By means of the sintering process or the casting, high constant compressive strain is applied to the contact surfaces of the nozzle disk, which compressive strain results in the above-mentioned advantages for the operation of the nozzle.

After the termination of the sintering or casting, the exterior surfaces or sealing surfaces of the sealing body are produced, and an exit bore and possibly an entry bore and the nozzle bore are provided. As a result, a high concentricity is reached which leads to an optimization of the medium jet emerging from the nozzle.

Since an operationally caused breaking of the nozzle disk is virtually excluded, the operational reliability for the user is increased in comparison to the known nozzle. Furthermore, the service life is also prolonged, and rises additionally because of the fact that the nozzle body with the embedded nozzle disk has a mirror-symmetrical construction in the longitudinal as well as the transverse axial direction. This permits a turning of the nozzle body in the event that the inlet area of the nozzle bore has been worn as a result of the operation. In this case, the nozzle body with the enclosed nozzle disk is only turned by 180°, so that the previous outlet side of the nozzle bore will now form the inlet side.

The nozzle disk can consist of a mechanically resistant ceramic material, preferably a sapphire, a ruby, a polycrystalline diamond or a mixed ceramics.

In addition to the above-mentioned possibility of embedding the nozzle disk by casting or sintering the nozzle body, there is also the possibility of soldering the nozzle disk to the nozzle body, preferably by means of hard-soldering.

In each case, the robust construction of the nozzle also permits the building-in of fan jet geometries of the nozzle bore, which may then have a cross-section which deviates from the circular shape, for example, an elliptical or rectangular shape. To this extent, the invention allows an expanded field of usage.

For prolonging the service life, in addition to the above-mentioned turning possibility of the nozzle body, the nozzle bore can be refinished, particularly in the area of the entry edge, so that, on the whole, a significant improvement is obtained from an industrial management point of view.

Additional advantageous embodiments of the invention are characterized in the subclaims.

Embodiments of the invention will be described in the following by means of the attached drawings.

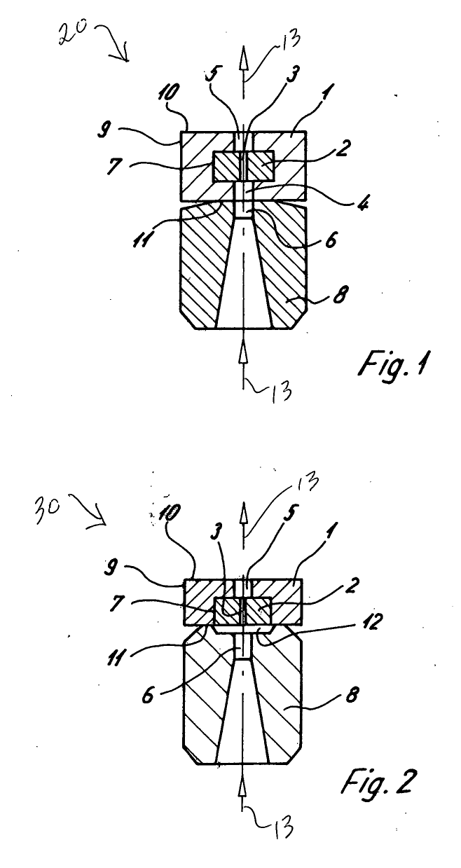

FIGS. 1 and 2 each are longitudinal sectional views of a nozzle according to the invention.

FIGS. 1 and 2 each show a nozzle for generating a high-pressure jet of a flowable medium, for example, a liquid, a liquid solids gas mixture or a gas, which, in its basic construction, has a nozzle body 1, a nozzle disk 2 resting in the nozzle body 1 inside a recess 7, consisting of a high-strength material, and having an axial, preferably centric nozzle bore 3 as well as an inflow body 8 by means of which the nozzle body 1 can be fixedly braced to a nozzle head in a nozzle housing which is not shown.

The inflow body 8, which, on its side facing the nozzle body 1, has an axially arranged feeding duct 6 through which the medium can be fed under pressure in the direction of the arrow, rests against the nozzle body 1 while forming a sealing surface 11 on the face side.

According to the invention, in the two illustrated embodiments, the nozzle disks 2, which preferably have a rotationally symmetrical shape, rest under compressive strain on the contact surfaces of the recess 7. In addition to having a cylindrical dimension, the nozzle disk 2 may naturally, depending on the requirements, also have other dimensions.

In the embodiment illustrated in FIG. 1, the nozzle disk 2 is completely enclosed by the nozzle body 1; that it, the nozzle disk is completely encased.

In contrast, in the embodiment illustrated in FIG. 2, the nozzle disk 2 rests only laterally and on the face situated opposite the inflow body 8 under compressive strain against the recess. In this case, the sealing surface 11 is bounded toward the center area by a free cut 12 which overlaps the facing front side of the nozzle disk 2 to such an extent that the sealing surface 11 rests against the nozzle body 1 outside the nozzle disk 2.

In both cases, the nozzle bore 3 leads into an outlet bore 5 of the nozzle body 1.

While, in the case of the nozzle illustrated in FIG. 1, the medium flowing through the feeding duct 6 is guided directly into an inlet bore 6 of the nozzle body 1 which is adjoined by the nozzle bore 3, in the case of the nozzle according to FIG. 2, the medium is fed to the nozzle bore 3 by way of the free cut 12 which concentrically adjoins the feeding duct 6.

As described above, the embedding of the nozzle disk 2 into the nozzle body 1 takes place by a pouring-around of the material then forming the nozzle body 1, by the sintering of this material or by soldering the nozzle disk 2 to the nozzle body 1.

A further machining of this constructional unit for providing the nozzle bore 3, the inlet bore 4, the outlet bore 5 as well as for producing an exterior surface 9 and a sealing surface 10 of the nozzle body 1, which forms the face opposite the inlet body 8, takes place subsequently without the necessity of taking into account narrow tolerances.

### List of Reference Numbers

1 Nozzle body

2 nozzle disk

3 nozzle bore

4 inlet bore

5 outlet bore

6 feeding duct

7 recess

8 inlet body

9 exterior surface

10 sealing surface

11 sealing surface

12 free cut

1. Nozzle for generating a high-pressure jet of a flowable medium, having a nozzle body (1) and a nozzle disk (2) which is embedded therein in a recess (7), consists of a high-strength material, and has an axial, preferably centric nozzle bore (3) which leads into an inlet and/or outlet bore (4, 5),
characterized in that the nozzle disk (2) rests under compressive strain on the contact surfaces of the recess (7).

2. Nozzle according to claim 1,
characterized in that the nozzle disk (2) is completely encased in the nozzle body (1).

3. Nozzle according to claim 1 or 2,
characterized in that the nozzle body (1) is shaped around the nozzle disk (2) by sintering or casting.

4. Nozzle according to claim 1,
characterized in that the nozzle disk (2) is soldered to the nozzle body (1), preferably by means of hard-soldering.

5. Nozzle according to one of claims 1 to 4,
characterized in that the nozzle bore (3) as well as the inlet and outlet bore (4, 5) are made after the encasing by means of casting or sintering.

6. Nozzle according to claim 1, wherein the nozzle body (1) can be braced by means of an inlet body (8) against a nozzle housing,
characterized in that the common pressure surfaces of the nozzle body (1) and of the inflow body (8) forming a sealing surface (11) are situated outside the nozzle disk (2).

7. Nozzle according to claim 6,
characterized in that, on its front side facing the nozzle body (1), the inlet body (8) has a concentric free cut (12) overlapping the sealing disk (2).

8. Nozzle according to one of claims 1 to 7,
characterized in that the nozzle body (1) and the embedded nozzle disk (2) have a mirror-symmetrical construction in the longitudinal as well as in the transverse direction.

9. Nozzle according to claim 1,
characterized in that the nozzle body (1) consists of a corrosion- and acid-resistant material.

10. Nozzle according to claim 1,
characterized in that the nozzle disk (2) consists of a polycrystalline diamond.

11. Nozzle according to claim 1,
characterized in that the nozzle bore (3) has a cross-section which deviates from the circular shape, preferably an elliptical or rectangular cross-section.
